(19) United States
(12) Patent Application Publication
(10) Pub. No.: US 2025/0291307 A1
(43) Pub. Date: Sep. 18, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Satoshi MIZOGUCHI, Kanagawa (JP); Hideya Katsuhara, Kanagawa (JP); Takahiro Suzuki, Kanagawa (JP)

(73) Assignee: FUJIFILM Business Innovation Corp., Tokyo (JP)

(21) Appl. No.: 18/808,441

(22) Filed: Aug. 19, 2024

(30) Foreign Application Priority Data
Mar. 13, 2024 (JP) 2024-039308

(51) Int. Cl. G03G 21/18; G03G 15/08

(52) U.S. Cl. CPC G03G 21/1814; G03G 15/0875; G03G 2215/0453; G03G 2215/046; G03G 2215/068

(57) ABSTRACT

An electrophotographic photoreceptor includes a conductive substrate, a charge generation layer on the conductive substrate, a charge transport layer on the charge generation layer, and a protection layer on the charge transport layer, in which a ratio L/ε of a total thickness L (μm) of the charge transport layer and the protection layer to a dielectric constant ε (F/m) of the charge transport layer and the protection layer as a whole in a thickness direction is 3 or more and 6 or less.

### CROSS-REFERENCE TO RELATED APPLICATIONS

This application is based on and claims priority under 35 USC 119 from Japanese Patent Application No. 2024-039308 filed Mar. 13, 2024.

### BACKGROUND

### (i) Technical Field

The present disclosure relates to an electrophotographic photoreceptor, a process cartridge, and an image forming apparatus.

### (ii) Related Art

Japanese Unexamined Patent Application Publication No. 2005-300742 discloses an image forming apparatus that does not include a charge erasing unit but includes an electrophotographic photoreceptor and an image forming unit, which includes a charging device, an exposing device, and a developing device, arranged along a transfer material conveying path, in which the electrophotographic photoreceptor is charged by applying only DC voltage to a charging member arranged in contact with the electrophotographic photoreceptor, and a toner image developed on the electrophotographic photoreceptor is directly transferred onto a conveyed transfer material to thereby form an image, and in which, when the electrophotographic photoreceptor is charged in a 23° C./55% RH environment to +500 V at the surface, the dark decay amount 1 minute after the charging is 15 V or less, and the thickness d of the charge transport layer of the electrophotographic photoreceptor, the specific dielectric constant ε of the binder resin in the charge transport layer, and the absolute value V of the photoreceptor dark potential satisfy formula (1): d÷ε×V≥3000.

Japanese Unexamined Patent Application Publication No. 2016-142916 discloses an image forming apparatus that includes an electrophotographic photoreceptor having a conductive substrate and a photosensitive layer on the conductive substrate and having an outermost surface layer composed of a cured film of a composition containing a reactive charge transport material, a charging unit disposed in contact with or near the surface of the electrophotographic photoreceptor to charge the surface of the electrophotographic photoreceptor, an electrostatic latent image forming unit that forms an electrostatic latent image on the charged surface of the electrophotographic photoreceptor, a developing unit that accommodates a developer containing a toner having toner particles and inorganic particles with a volume-average particle size of 1 μm or less and that develops the electrostatic latent image on the surface of the electrophotographic photoreceptor by using the developer to form a toner image, a transfer unit that transfers the toner image onto a surface of a recording medium, and a cleaning unit having a cleaning blade that contacts the surface of the electrophotographic photoreceptor and cleans the surface of the electrophotographic photoreceptor, in which at least a portion of the cleaning blade that contacts the electrophotographic photoreceptor is made of a plasma ion-injected rubber-modified portion.

Japanese Unexamined Patent Application Publication No. 2023-120986 discloses an electrophotographic photoreceptor that includes a conductive substrate having a thickness of 3 mm or more, a photosensitive layer on the conductive substrate, and a surface protection layer on the photosensitive layer, in which the surface protection layer is a layer composed of a cured film of a composition containing a reactive group-containing charge transport material having a reactive group and a charge transport skeleton in the same molecule or a cured film of a composition containing a non-reactive charge transport material and a reactive group-containing non-charge transport material containing no charge transport skeleton but containing a reactive group, and in which the ratio of the cure degree of the surface on the outer circumferential surface side to the cure degree of the surface on the conductive substrate side is 75% or more.

Japanese Unexamined Patent Application Publication No. 2023-142267 discloses a process cartridge that includes a photoreceptor including a conductive substrate, a photosensitive layer on the conductive substrate, and a protection layer on the photosensitive layer, and a roll-shaped charging member that contacts and charges the photoreceptor, in which the charges needed for charging the photoreceptor is 1.65 μC/(m²·V) or more.

### SUMMARY

Aspects of non-limiting embodiments of the present disclosure relate to providing an electrophotographic photoreceptor that causes less charging leakage (local charge leakage that occurs when the electrophotographic photoreceptor is charged) compared to an electrophotographic photoreceptor in which the ratio L/ε of a total thickness L (μm) of a charge transport layer and a protection layer to a dielectric constant ε (F/m) of the charge transport layer and the protection layer as a whole in a thickness direction is less than 3, and that causes less fogging (phenomenon in which the toner adhered to non-image portions of a recording medium) when images are continuously formed compared to an electrophotographic photoreceptor in which the ratio L/ε is more than 6.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electrophotographic photoreceptor includes a conductive substrate, a charge generation layer on the conductive substrate, a charge transport layer on the charge generation layer, and a protection layer on the charge transport layer, in which a ratio L/ε of a total thickness L (μm) of the charge transport layer and the protection layer to a dielectric constant ε (F/m) of the charge transport layer and the protection layer as a whole in a thickness direction is 3 or more and 6 or less.

### BRIEF DESCRIPTION OF THE DRAWINGS

Exemplary embodiments of the present disclosure will be described in detail based on the following figures, wherein:

FIG. 1 is a partial cross-sectional view schematically illustrating one example of the layer structure of an electrophotographic photoreceptor according to an exemplary embodiment;

FIG. 2 is a schematic view of one example of an image forming apparatus according to an exemplary embodiment; and

FIG. 3 is a schematic view of another example of an image forming apparatus according to an exemplary embodiment.

### DETAILED DESCRIPTION

Exemplary embodiments the present disclosure will now be described. The following descriptions and examples are mere examples of the exemplary embodiments and do not limit the scope of the exemplary embodiments.

In the present disclosure, “A and/or B” is synonymous with “at least one selected from A and B”. In other words, “A and/or B” means only A, only B, or the combination of A and B.

In the present disclosure, a numerical range expressed by using “to” indicates a range that includes the number preceding “to” and the number following “to” as the minimum value and the maximum value, respectively.

In any stepwise numerical range recited in the present disclosure, the upper limit or the lower limit of one numerical range may be substituted with the upper limit or the lower limit of any other stepwise numerical range. In any numerical range recited in the present disclosure, the upper limit or the lower limit of that numerical range may be substituted with any value disclosed in Examples.

In the present disclosure, the term “step” refers not only to an independent step but also to any feature that fulfills the intended purpose of that step although such a feature may not be clearly distinguishable from other steps.

When an exemplary embodiment in the present disclosure is described with reference to the drawings, that exemplary embodiment is not limited to the features illustrated in the drawings. In addition, the size of each of the members in the drawings is schematic, and the relative size relationships among the members are not limited to the ones illustrated in the drawings.

In the present disclosure, each component may contain multiple corresponding substances. In the present disclosure, when the amount of a component in a composition is described and when there are two or more substances that correspond to that component in the composition, the amount is the total amount of the two or more substances in the composition unless otherwise noted.

In the present disclosure, particles corresponding to each of the components may include multiple types of particles. When there are two or more types of particles corresponding to a component, the particle size of this component is the value from a mixture of the multiple types of particles present in the composition unless otherwise noted.

In the present disclosure, when a compound is represented by a structural formula, the symbols representing carbon atoms and hydrogen atoms (C and H) in hydrocarbon groups and/or hydrocarbon chains may be omitted.

In the present disclosure, an alkyl group and an alkylene group may be linear, branched, or cyclic unless otherwise noted.

In the present disclosure, a group such as an organic group, an aromatic ring, a linking group, an alkyl group, an alkylene group, an aryl group, an aralkyl group, an alkoxy group, or an aryloxy group may have a hydrogen atom therein substituted with a halogen atom.

In the present disclosure, “(meth)acryl” is a term that covers both acryl and methacryl, and “(meth)acrylate” is a term that covers both acrylate and methacrylate.

In the present disclosure, a “constitutional unit” of a copolymer or a resin is synonymous with a monomer unit.

In the present disclosure, the “axis direction” of an electrophotographic photoreceptor means the direction in which the rotation axis of the electrophotographic photoreceptor extends, and the “circumferential direction” of the electrophotographic photoreceptor means the direction in which the electrophotographic photoreceptor rotates.

### Electrophotographic Photoreceptor

An electrophotographic photoreceptor (hereinafter may also be referred to as a “photoreceptor”) according to an exemplary embodiment includes a conductive substrate, a charge generation layer on the conductive substrate, a charge transport layer on the charge generation layer, and a protection layer on the charge transport layer. The charge generation layer and the charge transport layer constitute a photosensitive layer (commonly known as a multilayer photosensitive layer or a function-separated photosensitive layer).

The photoreceptor according to the exemplary embodiment may further include layers (for example, an undercoat layer and an intermediate layer) other than the charge generation layer, the charge transport layer, and the protection layer.

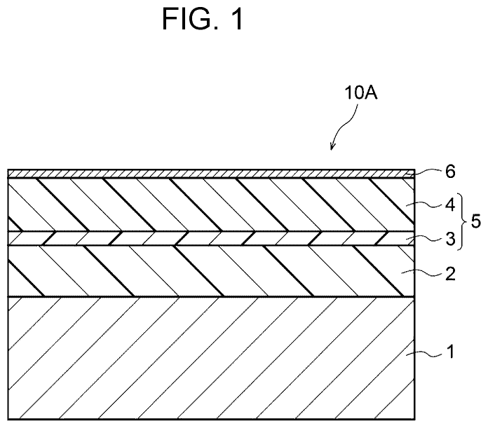

FIG. 1 is a partial cross-sectional view schematically illustrating one example of the layer structure of a photoreceptor according to an exemplary embodiment. A photoreceptor 10A has a structure in which an undercoat layer 2, a charge generation layer 3, a charge transport layer 4, and a protection layer 6 are stacked in this order on a conductive substrate 1, and the charge generation layer 3 and the charge transport layer 4 constitute a photosensitive layer 5. The photoreceptor 10A may include an intermediate layer (not illustrated) between the undercoat layer 2 and the charge generation layer 3. The undercoat layer 2 is optional.

According to the photoreceptor of this exemplary embodiment, the ratio L/ε of the total thickness L (μm) of the charge transport layer and the protection layer to the dielectric constant ε (F/m) of the charge transport layer and the protection layer as a whole in the thickness direction is 3 or more and 6 or less. The photoreceptor of this exemplary embodiment rarely undergoes charging leakage (local charge leakage that occurs when the photoreceptor is charged) or fogging (a phenomenon in which the toner adheres to non-image portions of a recording medium) in continuous image forming. The mechanism behind this is presumably as follows.

When an image forming apparatus equipped with a photoreceptor having a protection layer on the surface is used to continuously form images, fogging sometimes occurs. This phenomenon is particularly frequent with image forming apparatuses equipped with charge erasing devices that erase charges by irradiating the surface of the photoreceptor with charge erasing light. The cause for this is presumably that the charges generated in the charge generation layer as a result of the charge erasing light irradiation gradually accumulate in the charge transport layer and the protection layer, thereby gradually decreasing the surface potential of the photoreceptor.

In addition, this phenomenon is particularly ubiquitous in an image forming apparatus equipped with a charging device that has a charging member that contacts the photoreceptor and that applies only DC voltage to the charging member (hereinafter this device may be referred to as a “contact-type DC charging device”). It is presumed that while charges generated in the charge generation layer as a result of the charge erasing light irradiation accumulate in the charge transport layer and the protection layer, the accumulated charges migrate to the photoreceptor surface due to charging by the contact-type DC charging device, further promoting the decrease in surface potential of the photoreceptor.

According to the photoreceptor of this exemplary embodiment, a right balance is struck between the total thickness L (μm) of the charge transport layer and the protection layer and the dielectric constant ε (F/m) of the charge transport layer and the protection layer as a whole in the thickness direction so that accumulation of charges in the charge transport layer and the protection layer is inhibited and the decrease in surface potential of the photoreceptor and fogging are reduced.

According to the photoreceptor of this exemplary embodiment, the ratio L/ε of the total thickness L (μm) of the charge transport layer and the protection layer to the dielectric constant ε (F/m) of the charge transport layer and the protection layer as a whole in the thickness direction is 3 or more and 6 or less.

When the ratio L/ε is more than 6, the total thickness L of the charge transport layer and the protection layer is excessively large relative to the value of the dielectric constant ¿, charges generated in the charge generation layer due to the charge erasing light irradiation are likely to build up in the charge transport layer and the protection layer, and, as a result, the surface potential of the photoreceptor decreases and fogging occurs.

When the ratio L/ε is less than 3, the total thickness L of the charge transport layer and the protection layer is small, and the local charge leakage (charging leakage) is likely to occur when the photoreceptor is charged.

In order to suppress the aforementioned phenomenon, the ratio L/ε is preferably 3 or more and 6 or less, more preferably 4 or more and 6 or less, yet more preferably 4.5 or more and 5.8 or less, and particularly preferably 4.5 or more and 5.5 or less.

The total thickness L of the charge transport layer and the protection layer in the photoreceptor of this exemplary embodiment may be 10 μm or more and 20 μm or less.

When the total thickness L is 20 μm or less, the charges generated in the charge generation layer due to the charge erasing light irradiation are less likely to accumulate in the charge transport layer and the protection layer. From this viewpoint, the total thickness L is more preferably 18 μm or less.

When the total thickness L is 10 μm or more, the charging leakage is less likely to occur. From this viewpoint, the total thickness L is more preferably 12 μm or more.

The ratio L2/L1 of the thickness L2 of the protection layer to the thickness L1 of the charge transport layer in the photoreceptor of this exemplary embodiment may be 0.1 or more and 1 or less.

When the ratio L2/L1 is 1 or less, the charge transport layer is not excessively thin, which benefits the electrical characteristics of the photoreceptor. From this viewpoint, the ratio L2/L1 is more preferably 0.9 or less and yet more preferably 0.8 or less. When the ratio L2/L1 is 0.1 or more, the charging leakage is less likely to occur. From this viewpoint, the ratio L2/L1 is more preferably 0.3 or more and yet more preferably 0.5 or more.

In this exemplary embodiment, the thickness L1 of the charge transport layer, the thickness L2 of the protection layer, and the total thickness L of the charge transport layer and the protection layer are the following physical property values.

The thickness L1 of the charge transport layer is a value obtained by measuring the thickness of a charge transport layer with an Eddy current thickness meter at a total of 40 points taken at 10 equally spaced positions in the axis direction of the photoreceptor by 4 positions quadrisecting the photoreceptor in the circumferential direction (every) 90° and arithmetically averaging the results.

The thickness L2 of the protection layer is a value obtained by measuring the thickness of a protection layer with an Eddy current thickness meter at a total of 40 points at 10 equally spaced positions in the axis direction of the photoreceptor by 4 positions quadrisecting the photoreceptor in the circumferential direction (every) 90° and arithmetically averaging the results.

The total thickness L of the charge transport layer and the protection layer is the sum of the thickness L1 and the thickness L2.

The method for measuring the dielectric constant ε (F/m) of the charge transport layer and the protection layer as a whole in the thickness direction is as described below.

### Preparation of Electrostatic Capacitance Measurement Specimen

A portion near the surface of a photoreceptor is cut with a single-edged razor or the like, and the charge transport layer and the protection layer as an integral body are separated with tweezers. Gold electrodes are formed on both surfaces of the separated film (a multilayer film including a charge transport layer and a protection layer) by vacuum vapor deposition or sputtering to obtain an electrostatic capacitance measurement specimen.

### Electrostatic Capacitance Measurement by AC Impedance Method

The measurement instruments and conditions are as follows.
Power source: SI1287 electrochemical interface (Solartron Analytical)
Ammeter: SI1260 impedance/gain phase analyzer (Solartron Analytical)
Current amplifier: 1296 dielectric interface (Solartron Analytical)
AC voltage: 1 Vp-p
Measurement frequency: from 1 MHz to 1 mHz, applied from the high frequency side.
Measurement environment: temperature of 22° C. and relative humidity of 55%

The specimen is interposed between an aluminum plate (cathode) and a gold electrode (anode), the AC impedance is measured with the aforementioned measurement instruments under the aforementioned measurement conditions, and the measured Cole-Cole plot is fitted to a parallel RC equivalent circuit to determine the electrostatic capacitance. Formula: electrostatic capacitance C=dielectric constant ε×S/L (S: area of electrode, L: thickness of specimen) is used to calculate the dielectric constant ε.

The dielectric constant ε (F/m) of the charge transport layer and the protection layer as a whole in the thickness direction is preferably 3.0 or more and 4.0 or less, more preferably 3.1 or more and 3.8 or less, and yet more preferably 3.2 or more and 3.5 or less.

The dielectric constant ε (F/m) of the charge transport layer in the thickness direction is preferably 2.5 or more and 3.8 or less, more preferably 2.8 or more and 3.5 or less, and yet more preferably 3.0 or more and 3.3 or less.

The dielectric constant ε (F/m) of the protection layer in the thickness direction is preferably 3.2 or more and 4.5 or less, more preferably 3.4 or more and 4.2 or less, and yet more preferably 3.6 or more and 4.0 or less.

The methods for measuring the dielectric constant ε of the charge transport layer in the thickness direction and the dielectric constant ε of the protection layer in the thickness direction are the same as the method for measuring the dielectric constant ε of the charge transport layer and the protection layer as a whole in the thickness direction.

The dielectric constants ε (F/m) of the charge transport layer and the protection layer in the thickness direction can be controlled by the charge transport material content in each of the layers. The larger the charge transport material content, the smaller the dielectric constant ε.

The photoreceptor according to this exemplary embodiment may be used in an image forming apparatus equipped with a charging device that has a charging member in contact with the photoreceptor and applies only DC voltage to the charging member, and a charge erasing device that erases charges by irradiating the surface of the photoreceptor with charge erasing light after transfer of a toner image onto a surface of a recording medium.

Hereinafter, each of the layers of the electrophotographic photoreceptor of the present exemplary embodiment is described in detail.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. Here, “conductive” means having a volume resistivity of less than 1×10¹³ Ω·cm.

The surface of the conductive substrate may be roughened to a center-line average roughness Ra of 0.04 μm or more and 0.5 μm or less in order to reduce interference fringes that occur when the electrophotographic photoreceptor used in a laser printer is irradiated with a laser beam. When incoherent light is used as a light source, there is no need to roughen the surface to reduce interference fringes, but roughening the surface reduces generation of defects due to irregularities on the surface of the conductive substrate and thus is desirable for extending the lifetime.

Examples of the surface roughening method include a wet honing method with which an abrasive suspended in water is sprayed onto a conductive substrate, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that is highly variable depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be reduced.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated substrate may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

### Undercoat Layer

The undercoat layer is a layer containing, for example, inorganic particles and a binder resin.

Examples of the inorganic particles include inorganic particles that have a powder resistance (volume resistivity) of 1×10² Ω·cm or more and 1×10¹¹ Ω·cm or less.

As the inorganic particles having this resistance value, for example, metal oxide particles such as tin oxide particles, titanium oxide particles, zinc oxide particles, or zirconium oxide particles are preferable, and zinc oxide particles are particularly preferable.

The specific surface area of the inorganic particles as measured by a BET method may be, for example, 10 m²/g or more.

The volume-average particle diameter of the inorganic particles may be, for example, 50 nm or more and 2000 nm or less (preferably 60 nm or more and 1000 nm or less).

The amount of the inorganic particles contained relative to the binder resin is, for example, preferably 10 mass % or more and 80 mass % or less and more preferably 40 mass % or more and 80 mass % or less.

The inorganic particles may be surface-treated. Two or more types of inorganic particles subjected to different surface treatments or having different particle sizes may be mixed and used.

Examples of the surface treatment agent include a silane coupling agent, a titanate coupling agent, an aluminum coupling agent, and a surfactant. In particular, a silane coupling agent is preferable, and an amino-group-containing silane coupling agent is more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with an additional silane coupling agent. Examples of this additional silane coupling agent include, but are not limited to, vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treatment agent may be any known method, for example, may be a dry method or a wet method.

The treatment amount of the surface treatment agent may be, for example, 0.5 mass % or more and 10 mass % or less relative to the inorganic particles.

Here, from the viewpoint of enhancing the long-term stability of electrical properties and the carrier-blocking properties, the undercoat layer may contain an electron-accepting compound (acceptor compound) along with the inorganic particles.

Examples of the electron-accepting compound include quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; diphenoquinone compounds such as 3,3′,5,5′-tetra-t-butyldiphenoquinone; and benzophenone compounds.

In particular, a compound having an anthraquinone structure may be used as the electron-accepting compound. Examples of the compound having an anthraquinone structure include hydroxyanthraquinone compounds, aminoanthraquinone compounds, and aminohydroxyanthraquinone compounds, and more specific examples thereof include anthraquinone, alizarin, quinizarin, anthrarufin, and purpurin.

The electron-accepting compound may be dispersed in the undercoat layer along with the inorganic particles, or may be attached to the surfaces of the inorganic particles.

Examples of the method for attaching the electron-accepting compound onto the surfaces of the inorganic particles include a dry method and a wet method.

The dry method is, for example, a method with which, while inorganic particles are stirred with a mixer or the like having a large shear force, an electron-accepting compound as is or dissolved in an organic solvent is added dropwise or sprayed along with dry air or nitrogen gas so as to cause the electron-accepting compound to attach to the surfaces of the inorganic particles. When the electron-accepting compound is added dropwise or sprayed, the temperature may be equal to or lower than the boiling point of the solvent. After the electron-accepting compound is added dropwise or sprayed, baking may be further conducted at 100° C. or higher. The temperature and time for baking are not particularly limited as long as the electrophotographic properties are obtained.

The wet method is, for example, a method with which, while inorganic particles are dispersed in a solvent by stirring, ultrasonically, or by using a sand mill, an attritor, or a ball mill, the electron-accepting compound is added, followed by stirring or dispersing, and then the solvent is removed to cause the electron-accepting compound to attach to the surfaces of the inorganic particles. The solvent is removed by, for example, filtration or distillation. After removing the solvent, baking may be further conducted at 100° C. or higher. The temperature and time for baking are not particularly limited as long as the electrophotographic properties are obtained. In the wet method, the moisture contained in the inorganic particles may be removed before adding the electron-accepting compound; for example, the moisture may be removed by stirring and heating the inorganic particles in a solvent or by boiling together with the solvent.

The electron-accepting compound may be attached before, after, or at the same time as surface-treating the inorganic particles with a surface treatment agent.

The amount of the electron-accepting compound contained relative to the inorganic particles may be, for example, 0.01 mass % or more and 20 mass % or less, and is preferably 0.01 mass % or more and 10 mass % or less.

Examples of the binder resin used in the undercoat layer include known materials such as known polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Other examples of the binder resin used in the undercoat layer include charge transport resins that have charge transport groups, and conductive resins (for example, polyaniline).

Among these, a resin that is insoluble in the coating solvent in the overlying layer is suitable as the binder resin used in the undercoat layer, and examples of the particularly suitable resin include thermosetting resins such as a urea resin, a phenolic resin, a phenol-formaldehyde resin, a melamine resin, a urethane resin, an unsaturated polyester resin, an alkyd resin, and an epoxy resin; and a resin obtained by a reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin.

When two or more of these binder resins are used in combination, the mixing ratios are set as necessary.

The undercoat layer may contain various additives to improve electrical properties, environmental stability, and image quality.

Examples of the additives include known materials such as electron transporting pigments based on polycyclic condensed materials and azo materials, zirconium chelate compounds, titanium chelate compounds, aluminum chelate compounds, titanium alkoxide compounds, organic titanium compounds, and silane coupling agents. The silane coupling agent is used to surface-treat the inorganic particles as mentioned above, but may be further added as an additive to the undercoat layer.

Examples of the silane coupling agent that serves as an additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxyaluminum diisopropylate, aluminum butyrate, ethylacetoacetate aluminum diisopropylate, and aluminum tris(ethylacetoacetate).

These additives may be used alone, or two or more compounds may be used as a mixture or a polycondensation product.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of the laser wavelength λ used for exposure.

In order to adjust the surface roughness, resin particles and the like may be added to the undercoat layer. Examples of the resin particles include silicone resin particles and crosslinking polymethyl methacrylate resin particles. The surface of the undercoat layer may be polished to adjust the surface roughness. Examples of the polishing method include buff polishing, sand blasting, wet honing, and grinding.

The undercoat layer may be formed by any known method, for example, by forming a coating film with an undercoat-layer-forming solution containing the aforementioned components and a solvent, drying the coating film, and if necessary, heating the dried coating film.

Examples of the solvent used for preparing the undercoat layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing inorganic particles in preparing the undercoat layer-forming solution include known methods that use a roll mill, a ball mill, a vibrating ball mill, an attritor, a sand mill, a colloid mill, and a paint shaker.

Examples of the method for applying the undercoat layer-forming solution to the conductive substrate include common methods such as a blade coating method, a wire bar coating method, a spray coating method, a dip coating method, a bead coating method, an air knife coating method, and a curtain coating method.

The thickness of the undercoat layer is, for example, preferably 15 μm or more, and more preferably within the range of 20 μm or more and 50 μm or less.

Intermediate layer

An intermediate layer may be further provided between the undercoat layer and the photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compounds used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method, for example, by forming a coating film with an intermediate-layer-forming solution containing the aforementioned components and a solvent, drying the coating film, and, if necessary, heating the dried coating film.

Examples of the application method for forming the intermediate layer include common methods such as a dip coating method, a lift coating method, a wire bar coating method, a spray coating method, a blade coating method, an air knife coating method, and a curtain coating method.

The thickness of the intermediate layer may be set within the range of, for example, 0.1 μm or more and 3 μm or less. The intermediate layer may be used as the undercoat layer.

### Charge Generation Layer

The charge generation layer is, for example, a layer that contains a charge generation material and a binder resin. The charge generation layer may be a vapor deposited layer of a charge generation material. The vapor deposited layer of the charge generation material may be used when an incoherent light source such as a light emitting diode (LED) or an organic electroluminescence (EL) image array is used.

Examples of the charge generation material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, a metal phthalocyanine pigment or a metal-free phthalocyanine pigment may be used as the charge generation material in order to be used for near-infrared laser exposure. Specifically, for example, hydroxygallium phthalocyanine, chlorogallium phthalocyanine, dichlorotin phthalocyanine, and titanyl phthalocyanine are more preferable.

Meanwhile, for use with near-ultraviolet laser exposure, the charge generation material is preferably a fused-ring aromatic pigment such as dibromoanthanthrone, a thioindigo pigment, a porphyrazine compound, zinc oxide, trigonal selenium, a bisazo pigment, or the like.

When an incoherent light source, such as an LED or an organic EL image array having an emission center wavelength in the range of 450 nm or more and 780 nm or less, is used, the charge generation material described above may also be used.

When an n-type semiconductor, such as a fused-ring aromatic pigment, a perylene pigment, or an azo pigment, is used as the charge generation material, dark current rarely occurs and, even when the thickness is small, image defects known as black spots can be suppressed. The conductivity type is determined by a commonly practiced time-of-flight method by the polarity of the flowing photocurrent, and a material in which electrons rather than holes are likely to flow as a carrier is determined to be of an n-type.

The binder resin used in the charge generation layer is selected from a wide range of insulating resins. Alternatively, the binder resin may be selected from organic photoconductive polymers, such as poly-N-vinylcarbazole, polyvinyl anthracene, polyvinyl pyrene, and polysilane.

Examples of the binder resin include, polyvinyl butyral resins, polyarylate resins (polycondensates of bisphenols and aromatic dicarboxylic acids etc.), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. Here, “insulating” means having a volume resistivity of 1×10¹³ Ω·cm or more.

These binder resins may be used alone or in combination as a mixture.

The blend ratio of the charge generation material to the binder resin may be 10:1 to 1:10 in terms of mass ratio.

The charge generation layer may contain other known additives.

The charge generation layer may be formed by any known method, and, for example, may be formed by preparing a charge generation layer-forming solution by adding the above-mentioned components to a solvent, forming a coating film of this solution, and drying and, if desired, heating the coating film. The charge generation layer may be a vapor deposited layer of a charge generation material. The charge generation layer may be formed by vapor deposition particularly when a fused-ring aromatic pigment or a perylene pigment is used as the charge generation material.

Specific examples of the solvent for preparing the charge generation layer-forming solution include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in combination as a mixture.

In order to disperse particles (for example, a charge generation material) in the charge generation layer-forming solution, a media disperser such as a ball mill, a vibrating ball mill, an attritor, a sand mill, or a horizontal sand mill, or a media-less disperser such as stirrer, an ultrasonic disperser, a roll mill, or a high-pressure homogenizer is used, for example. Examples of the high-pressure homogenizer include a collision-type homogenizer in which a dispersion in a high-pressure state is dispersed through liquid-liquid collision or liquid-wall collision, and a penetration-type homogenizer in which a fluid in a high-pressure state is caused to penetrate through fine channels.

In dispersing, it is effective to set the average particle diameter of the charge generation material in the charge generation layer-forming solution to 0.5 μm or less, preferably 0.3 μm or less, and more preferably 0.15 μm or less.

Examples of the method for applying the charge generation layer-forming solution to the undercoat layer (or the intermediate layer) include common methods such as a blade coating method, a wire bar coating method, a spray coating method, a dip coating method, a bead coating method, an air knife coating method, and a curtain coating method.

The thickness of the charge generation layer is preferably set within the range of 0.1 μm or more and 5.0 μm or less, and more preferably within the range of 0.2 μm or more and 2.0 μm or less.

### Charge Transport Layer

The charge transport layer is, for example, a layer that contains a charge transport material and a binder resin. The charge transport layer may contain a polymer charge transport material.

Examples of the charge transport material include electron transport compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the charge transport material include hole transport compounds such as triarylamine compounds, benzidine compounds, arylalkane compounds, aryl-substituted ethylene compounds, stylbene compounds, anthracene compounds, and hydrazone compounds. These charge transport materials are used alone or in combination, and are not limiting.

From the viewpoint of charge mobility, the charge transport material may be a triarylamine derivative represented by structural formula (a-1) below and a benzidine derivative represented by structural formula (a-2) below.

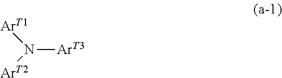

In structural formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent for each of the groups described above include a halogen atom, an alkyl group having 1 or more and 5 or less carbon atoms, and an alkoxy group having 1 or more and 5 or less carbon atoms. Examples of the substituent for each of the groups described above also include substituted amino groups each of which is substituted with an alkyl group having 1 or more and 3 or less carbon atoms.

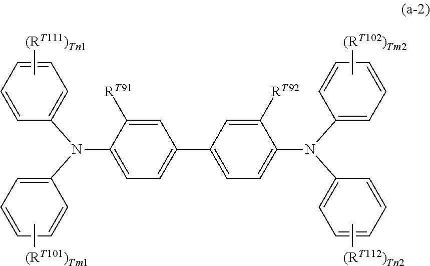

In structural formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent for each of the groups described above include a halogen atom, an alkyl group having 1 to 5 carbon atoms, and an alkoxy group having 1 to 5 carbon atoms. Examples of the substituent for each of the groups described above also include substituted amino groups each of which is substituted with an alkyl group having 1 or more and 3 or less carbon atoms.

Among the triarylamine derivatives represented by structural formula (a-1) above and the benzidine derivatives represented by structural formula (a-2) above, a triarylamine derivative having “—C₆H₄—CH═CH—CH—C(R^{T7})(R^{T8})” and a benzidine derivative having “—CH═CH—CH═C(R^{T15})(R^{T16})” are preferable from the viewpoint of charge mobility.

Examples of the polymer charge transport material that can be used include known charge transport materials such as poly-N-vinylcarbazole and polysilane. In particular, a polyester polymer charge transport material is preferable. These polymer charge transport materials may be used alone or each in combination with a binder resin.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. These binder resins are used alone or in combination. The blend ratio of the charge transport material to the binder resin may be 10:1 to 1:5 in terms of mass ratio.

From the viewpoint of the durability of the charge transport layer, at least one selected from the group consisting of polycarbonate resins and polyarylate resins may be used as the binder resin. In using polycarbonate resins and polyarylate resins, only polycarbonate resins or polyarylate resins may be used, or a polycarbonate resin and a polyarylate resin may be mixed and used.

The charge transport layer may contain other known additives. Examples of the additives include an antioxidant, a leveling agent, a defoamer, a filler, and a viscosity adjustor.

The charge transport layer may be formed by any known method, and, for example, may be formed by preparing a charge transport layer-forming solution by adding the above-mentioned components to a solvent, forming a coating film of this solution, and drying and, if desired, heating the coating film.

Examples of the solvent used to prepare the charge transport layer-forming solution include common organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the charge transport layer-forming solution to the charge generation layer include common methods such as a blade coating method, a wire bar coating method, a spray coating method, a dip coating method, a bead coating method, an air knife coating method, and a curtain coating method.

The thickness of the charge transport layer is preferably 5 μm or more and 30 μm or less, more preferably 8 μm or more and 20 μm or less, and yet more preferably 10 μm or more and 15 μm or less.

When the thickness of the charge transport layer is 30 μm or less, the charges generated in the charge generation layer due to the charge erasing light irradiation are less likely to accumulate in the charge transport layer, and thus less fogging occurs in the images. From this viewpoint, the thickness of the charge transport layer is preferably 20 μm or less and more preferably 15 μm or less.

The thickness of the charge transport layer may be 5 μm or less from the viewpoint of the electrical characteristics of the photoreceptor. From this viewpoint, the thickness of the charge transport layer is more preferably 8 μm or more and yet more preferably 10 μm or more.

### Protection Layer

A protection layer is disposed on the photosensitive layer. The protection layer constitutes the outermost surface layer of the photoreceptor. The protection layer is, for example, provided for the purpose of preventing chemical changes in the photosensitive layer during charging and the purpose of improving the mechanical strength of the photosensitive layer.

The protection layer may be a layer formed by a cured film or crosslinked film, and preferably takes the form of (1) or (2) below. According to the form (1) or (2) below, the chemical changes in the photosensitive layer during charging is reduced, and the wear resistance of the protection layer is improved.

Form (1): A cured film or a crosslinked film of a composition that contains a reactive charge transport material that has a reactive group and a charge transport skeleton in the same molecule. In other words, this layer is a layer containing a polymer or a crosslinked body of a reactive charge transport material. This layer may contain a polymer or a crosslinked body of a reactive non-charge transport material that has a reactive group but not a charge transport skeleton in the molecule. This layer may also contain a polymer or a crosslinked body of a reactive charge transport material and a reactive non-charge transport material. This layer may also contain a non-reactive charge transport material that does not have a reactive group in the molecule.

Form (2): A cured film or a crosslinked film of a composition that contains a non-reactive charge transport material that does not have a reactive group in the molecule and a reactive non-charge transport material that has a reactive group but not a charge transport skeleton in the molecule. In other words, this layer is a layer containing a polymer or a crosslinked body of a non-reactive charge transport material and a reactive non-charge transport material.

The protection layer preferably takes form (1) among forms (1) and (2). Compared to form (2), form (1) offers a protection layer with higher hardness and higher wear resistance.

The reactive charge transport material, the non-reactive charge transport material, and the reactive non-charge transport material may be selected from among known materials. Examples of the reactive charge transport material, the non-reactive charge transport material, and the reactive non-charge transport material will now be described.

Examples of the reactive group in the reactive charge transport material include known reactive groups such as chain-polymerizable groups, an epoxy group, —OH, —OR (where R represents an alkyl group), —NH₂, —SH, —COOH, and —SiR^{a}₃₋ₙ(OR^{b})ₙ (where R^{a} represents a hydrogen atom, an alkyl group, or a substituted or unsubstituted aryl group, Rb represents a hydrogen atom, an alkyl group, or a trialkylsilyl group, and n represents an integer of 1 or more and 3 or less). Examples of the reactive group in the reactive non-charge transport material are as described above.

The chain-polymerizable group may be any radical-polymerizable functional group, for example, a functional group that has a carbon-carbon double bond. A specific example thereof is a group that contains at least one selected from a vinyl group, a vinyl ether group, a vinyl thioether group, a styryl group (phenylvinyl group), a vinylphenyl group, an acryloyl group, a methacryloyl group, and derivatives thereof. Among these, due to excellent reactivity, the chain-polymerizable group may be a group that contains at least one selected from a vinyl group, a styryl group (phenylvinyl group), a vinylphenyl group, an acryloyl group, a methacryloyl group, and derivatives thereof.

Examples of the charge transport skeleton in the reactive charge transport material include skeletons that are derived from nitrogen-containing hole transport compounds such as triarylamine compounds (compounds having triarylamine skeletons), benzidine compounds (compounds having benzidine skeletons), and hydrazone compounds (compounds having hydrazone skeletons) and that are conjugated with nitrogen atoms. Among these, a triarylamine skeleton is preferable as the charge transport skeleton of the reactive charge transport material.

The reactive charge transport materials may be used alone or in combination.

From the viewpoint of excellent charge transport properties, the reactive charge transport material may be a compound represented by formula (A) below.

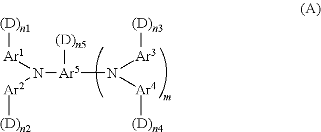

In formula (A), Ar¹, Ar², Ar³, and Ar⁴ each independently represent a substituted or unsubstituted aryl group, Ar⁵ represents a substituted or unsubstituted aryl group or a substituted or unsubstituted arylene group, D represents an organic group having a chain polymerizable group, an epoxy group, —OH, —OR (where R represents an alkyl group), —NH₂, —SH, —COOH, or —SiR^{a}₃₋ₙ(OR^{b})ₙ (where R^{a} represents a hydrogen atom, an alkyl group, or a substituted or unsubstituted aryl group, R^{b} represents a hydrogen atom, an alkyl group, or a trialkylsilyl group, and n represents an integer of 1 or more and 3 or less), n1, n2, n3, n4, and n5 each independently represent an integer of 0 or more and 2 or less, m represents 0 or 1, and the total number of D is 1 or more and 8 or less.

From the viewpoint of obtaining a protection layer having higher strength, the total number of D is preferably 2 or more and more preferably 4 or more. From the viewpoint of decreasing the percentage of unreacted reactive groups, the total number of D is preferably 7 or less and more preferably 6 or less.

In formula (A), Ar¹, Ar², Ar³, and Ar⁴ each independently represent a substituted or unsubstituted aryl group. Ar¹, Ar², Ar³, and Ar⁴ may be the same or different.

Examples of the substituent in the substituted aryl group other than D include alkyl group having 1 or more and 4 or less carbon atoms, an alkoxy group having 1 or more and 4 or less carbon atoms, and a substituted or unsubstituted aryl group having 6 or more and 10 or less carbo atoms.

In formula (A), —Ar¹-(D)ₙ₁, —Ar²-(D)ₙ₂, —Ar³-(D)ₙ₃, and —Ar₄-(D)ₙ₄ may each independently represent one of formulae (1) to (7) below.

In formulae (1) to (7) below, -(D)ₙ₁, -(D)ₙ₂, -(D)ₙ₃, and -(D)ₙ₄ respectively linked to Ar¹, Ar², Ar³, and Ar⁴ are generally expressed as -(D)ₙ.

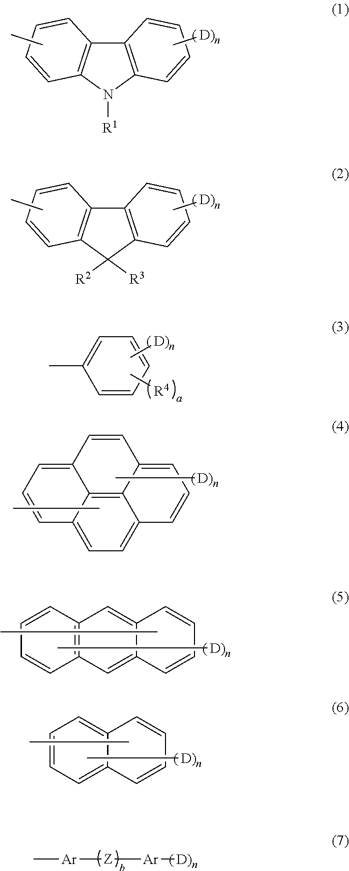

In formulae (1) to (7), D is the same as “D” in formula (A), and n represents 1 or 2.

In formula (1), R¹ represents a hydrogen atom, an alkyl group having 1 or more and 4 or less carbon atoms, an alkoxy group having 1 or more and 4 or less carbon atoms, an unsubstituted phenyl group, or a phenyl group substituted with an alkyl group having 1 or more and 4 or less carbon atoms or an alkoxy group having 1 or more and 4 or less carbon atoms.

In formula (2), R² and R³ each independently represent a hydrogen atom, an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom.

In formula (3), R⁴ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and a represents an integer of 0 or more and 4 or less.

In formula (7), two Ar each independently represent a substituted or unsubstituted arylene group, Z represents a divalent organic linking group, and b represents 0 or 1.

Ar in formula (7) may be an arylene group represented by formula (8) below or an arylene group represented by formula (9) below.

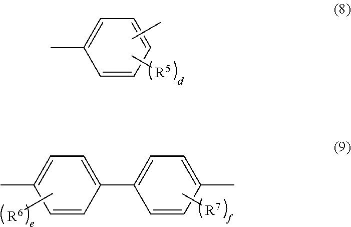

In formula (8), R⁵ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and d represents an integer of 0 or more and 4 or less.

In formula (9), R⁶ and R⁷ each independently represent an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, and e and f each independently represent an integer of 0 or more and 4 or less.

Z in formula (7) may be a divalent linking group represented by formula (10) below, a divalent linking group represented by formula (11), a divalent linking group represented by formula (12), a divalent linking group represented by formula (13), a divalent linking group represented by formula (14), a divalent linking group represented by formula (15), a divalent linking group represented by formula (16), a divalent linking group represented by formula (17), or any combination of these.

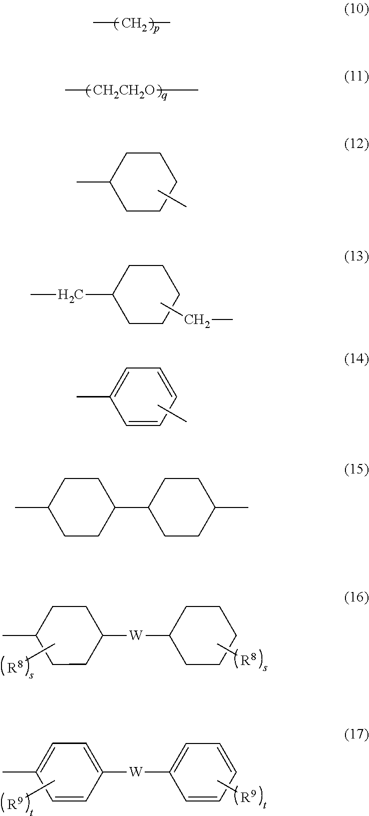

In formula (10), p represents an integer of 1 or more and 10 or less.

In formula (11), q represents an integer of 1 or more and 10 or less.

In formula (16), R⁸ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, s represents an integer of 0 or more and 4 or less, and W represents a divalent linking group.

In formula (17), R⁹ represents an alkyl group having 1 or more and 4 or less carbon atoms, an alkoxy group having 1 or more and 4 or less carbon atoms, an unsubstituted phenyl group, a phenyl group substituted with an alkyl group having 1 or more and 4 or less carbon atoms or an alkoxy group having 1 or more and 4 or less carbon atoms, or a halogen atom, t represents an integer of 0 or more and 4 or less, and W represents a divalent linking group.

W in formulae (16) and (17) may be a divalent linking group represented by formula (18) below, a divalent linking group represented by formula (19), a divalent linking group represented by formula (20), a divalent linking group represented by formula (21), a divalent linking group represented by formula (22), a divalent linking group represented by formula (23), a divalent linking group represented by formula (24), a divalent linking group represented by formula (25), or a divalent linking group represented by formula (26).

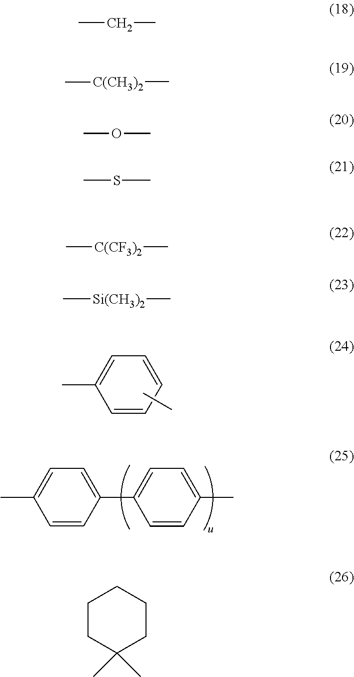

In formula (25), u represents an integer of 0 or more and 3 or less.

In formula (A), when m is 0, Ar⁵ is a substituted or unsubstituted aryl group. Examples of the aryl group represented by Ar⁵ include the aforementioned aryl groups that have been described above as the preferable examples of Ar¹ etc.

In formula (A), when m is 1, Ar⁵ is a substituted or unsubstituted arylene group. Examples of the arylene group represented by Ar⁵ include those arylene groups obtained by removing, from the aforementioned aryl groups that have been described as the preferable examples of Ar¹, hydrogen atoms at the substitution position of —N(Ar³-(D)ₙ₃)(Ar⁴-(D)ₙ₄).

Some examples of the reactive charge transport material are CTM(R1) to CTM(R4) and CTM(CP1) to CTM(CP4) described below.

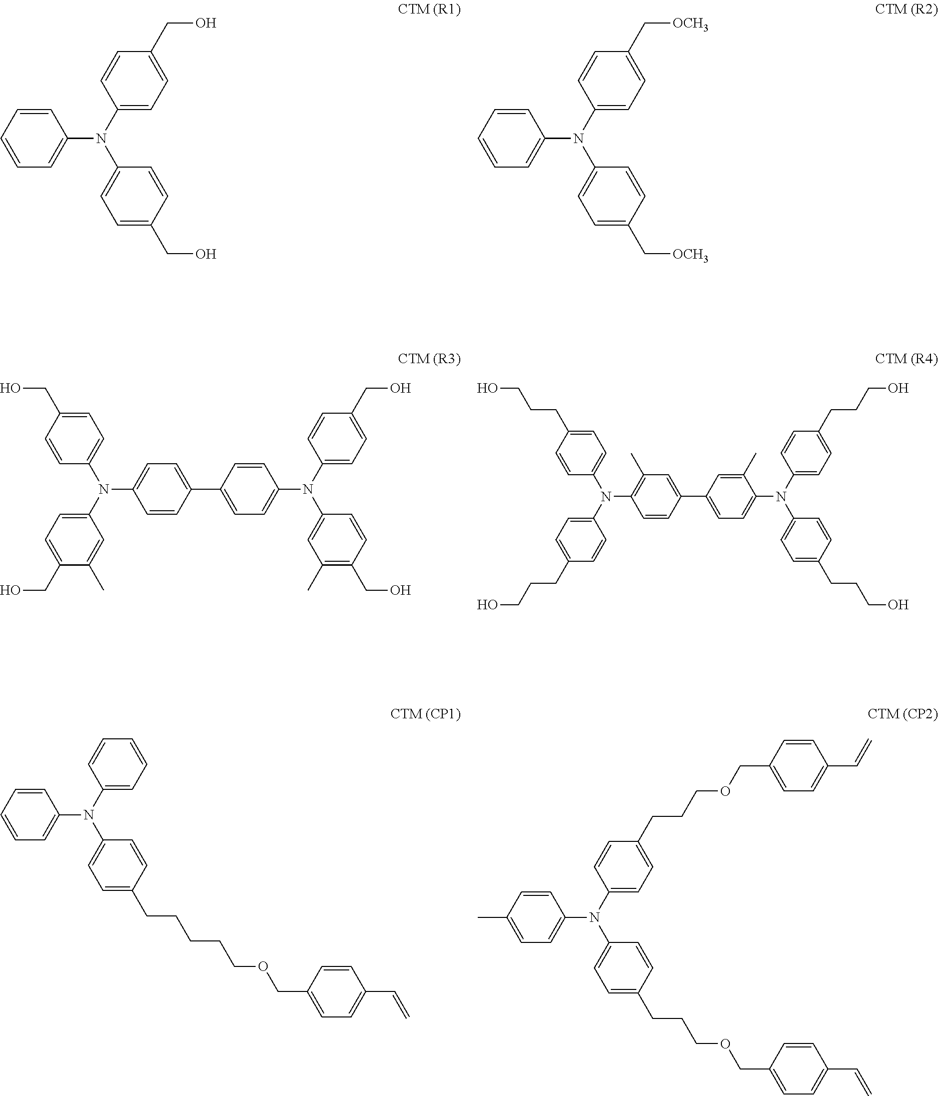 [SMILES: OCc1ccc(N(c2ccccc2)c2ccc(CO)cc2)cc1 ; COCc1ccc(N(c2ccccc2)c2ccc(COC)cc2)cc1 ; Cc1cc(N(c2ccc(CO)cc2)c2ccc(-c3ccc(N(c4ccc(CO)cc4)c4ccc(CO)c(C)c4)cc3)cc2)ccc1CO ; Cc1cc(-c2ccc(N(c3ccc(CCCO)cc3)c3ccc(CCCO)cc3)c(C)c2)ccc1N(c1ccc(CCCO)cc1)c1ccc(CCCO)cc1 ; C=Cc1ccc(COCCCCCc2ccc(N(c3ccccc3)c3ccccc3)cc2)cc1 ; C=Cc1ccc(COCCCc2ccc(N(c3ccc(C)cc3)c3ccc(CCCOCc4ccc(C=C)cc4)cc3)cc2)cc1]

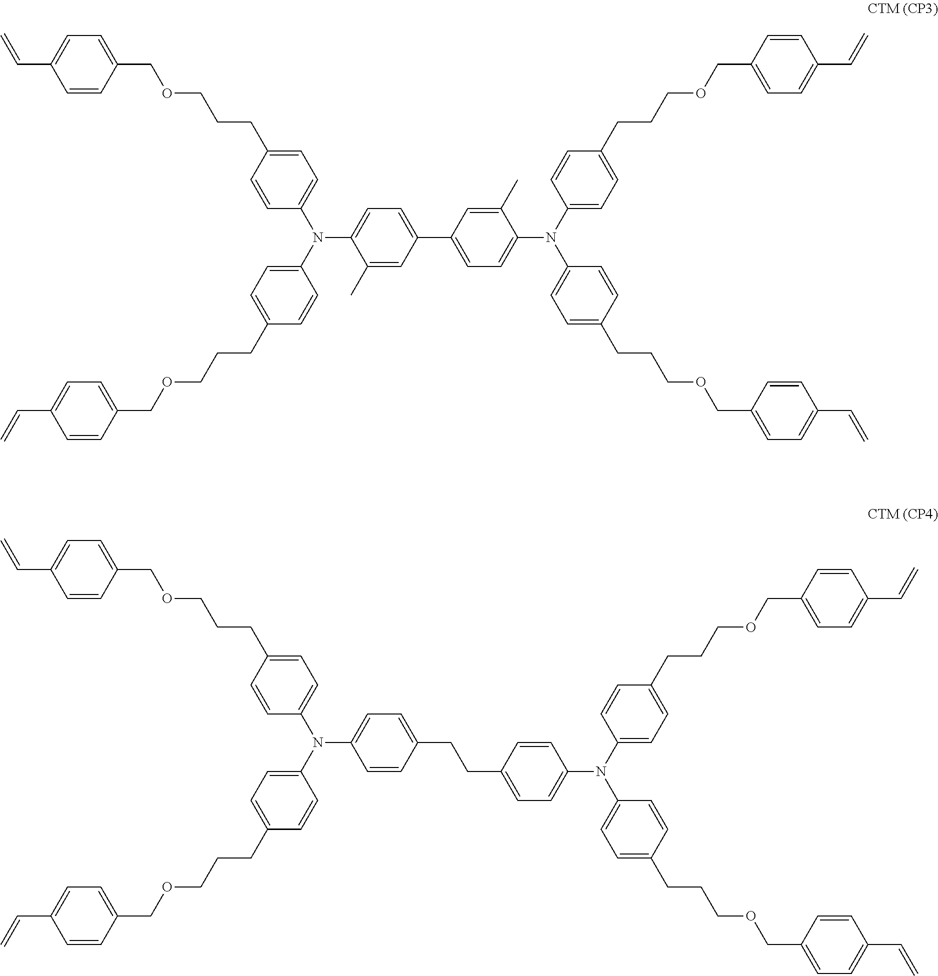

The reactive charge transport material content relative to the solid content of the composition for forming the protection layer (for example, a protection layer-forming solution) is preferably 30 mass % or more and 100 mass % or less, more preferably 40 mass % or more and 100 mass % or less, and yet more preferably 50 mass % or more and 100 mass % or less. When the reactive charge transport material content is within this range, the protection layer can be made relatively thick, and thus the charging leakage on the photoreceptor surface is inhibited.

When a chain polymerizable charge transport material is used as the reactive charge transport material, the chain polymerizable charge transport material content relative to the solid content of the composition for forming the protection layer (for example, a protection layer-forming solution) is preferably 30 mass % or more and 100 mass % or less, more preferably 40 mass % or more and 100 mass % or less, and yet more preferably 50 mass % or more and 100 mass % or less. When the chain polymerizable charge transport material content is within this range, the protection layer can be made relatively thick, and thus the charging leakage on the photoreceptor surface is inhibited.

Examples of the non-reactive charge transport material include electron transport compounds such as quinone compounds such as p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. Other examples of the non-reactive charge transport material include hole transport compounds such as triarylamine compounds, benzidine compounds, arylalkane compounds, aryl-substituted ethylene compounds, stylbene compounds, anthracene compounds, and hydrazone compounds. The non-reactive charge transport materials may be used alone or in combination.

One example of the non-reactive charge transport material is CTM(NR1) described below.

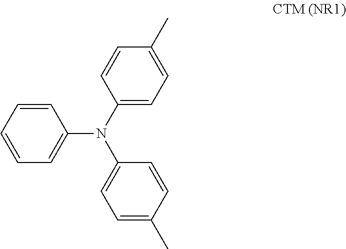 [SMILES: Cc1ccc(N(c2ccccc2)c2ccc(C)cc2)cc1]

Examples of the reactive non-charge transport material include thermosetting resins and curing agents. The reactive non-charge transport materials may be used alone or in combination.

Examples of the thermosetting resins include guanamine resins, melamine resins, phenolic resins, urea resins, and alkyd resins.

Examples of the curing agent include guanamine structure-containing compounds (hereinafter may also be referred to as “guanamine compounds”), and melamine structure-containing compounds (hereinafter may also be referred to as “melamine compounds”).

An exemplary embodiment of the protection layer is a cured film or crosslinked film that contains a polymer or a crosslinked body obtained from a reactive charge transport material and at least one selected from the group consisting of a guanamine resin, a melamine resin, a guanamine compound, and a melamine compound. A protection layer formed by the cured film or crosslinked film have higher wear resistance.

The protection layer may contain fluororesin particles. The protection layer containing fluororesin particles have irregularities formed on the outer circumferential surface of the protection layer, and thus the wear resistance is further improved.

Examples of the fluororesin constituting the fluororesin particles include polytetrafluoroethylene (PTFE, aka tetrafluoroethylene resin), perfluoroalkoxy fluororesin, polychlorotrifluoroethylene, polyvinylidene fluoride, polydichlorodifluoroethylene, tetrafluoroethylene-perfluoroalkyl vinyl ether copolymer, tetrafluoroethylene-hexafluoropropylene copolymer, tetrafluoroethylene-ethylene copolymer, tetrafluoroethylene-hexafluoropropylene-perfluoroalkyl vinyl ether copolymer, and tetrafluoroethylene-perfluoroalkoxyethylene copolymer. The fluororesin constituting the fluororesin particles is preferably polytetrafluoroethylene or a copolymer of tetrafluoroethylene and perfluoroalkoxyethylene from the viewpoints of the wear resistance and cleaning properties of the protection layer. The fluororesin particles may be one type of fluororesin particles or a combination of two or more types of fluororesin particles.

The weight-average average molecular weight of the fluororesin constituting the fluororesin particles may be 3,000 or more and 5,000,000 or less.

The average primary diameter of the fluororesin particles is preferably 0.05 μm or more and 10 μm or less and more preferably 0.1 μm or more and 5 μm or less.

The average primary diameter of the fluororesin particles is a value obtained by measuring a dispersion containing dispersed fluororesin particles by using a laser diffraction-scattering particle size distribution analyzer at a refractive index of 1.35.

The mass ratio of the fluororesin particles in the protection layer is preferably 5 mass % or more and 15 mass % or less and more preferably 7 mass % or more and 12 mass % or less.

The protection layer is formed by, for example, preparing a protection layer-forming solution containing the aforementioned components and a solvent or a dispersion medium, applying the protection layer-forming solution to a photosensitive layer to form a coating film, and drying the coating film. If necessary, the coating film is cured by heating, for example.

Examples of the solvent or dispersion medium used to prepare the protection layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents may be used alone or in combination.

Examples of the method for applying the protection layer-forming solution to the photosensitive layer include common methods such as a dip coating method, a lift coating method, a wire bar coating method, a spray coating method, a blade coating method, an air knife coating method, and a curtain coating method.

The thickness of the protection layer is preferably 2 μm or more and 10 μm or less, more preferably 3 μm or more and 9 μm or less, and yet more preferably 4 μm or more and 8 μm or less.

When the thickness of the protection layer is 10 μm or less, the charges generated in the charge generation layer due to the charge erasing light irradiation are less likely to accumulate in the protection layer, and thus less fogging occurs in the images. From this viewpoint, the thickness of the protection layer is preferably 9 μm or less and more preferably 8 μm or less.

When the thickness of the protection layer is 2 μm or more, the charging leakage is less likely to occur on the photoreceptor surface. From this viewpoint, the thickness of the protection layer is more preferably 3 μm or more and yet more preferably 4 μm or more.

### Image Forming Apparatus and Process Cartridge

An image forming apparatus of an exemplary embodiment includes an electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image on the surface of the electrophotographic photoreceptor by using a developer that contains a toner so as to form a toner image, a transfer device that transfers the toner image onto a surface of a recording medium, and a charge erasing device that erases charges by irradiating the surface of the electrophotographic photoreceptor with charge erasing light after transfer of the toner image onto the surface of the recording medium. Here, the electrophotographic photoreceptor of the present exemplary embodiment is used as the electrophotographic photoreceptor.

The image forming apparatus of this exemplary embodiment is equipped with a charge erasing device. An image forming apparatus equipped with a charge erasing device has a tendency to generate fogging when images are continuously formed. Generation of fogging that would occur during continuous image formation is inhibited by using the electrophotographic photoreceptor of this exemplary embodiment with an image forming apparatus equipped with a charge erasing device.

The charging device in the image forming apparatus of the exemplary embodiment may be a charging device having a charging member that contacts the surface of the electrophotographic photoreceptor (contact system) or a charging device having a charging member that does not contact the surface of the electrophotographic photoreceptor (non-contact system).

The charging device in the image forming apparatus of the exemplary embodiment may be a charging device that has a system of applying only DC voltage to the charging member (DC charging system); a charging device that has a system of applying only AC voltage to the charging member (AC charging system); or a charging device that has a system of applying AC voltage superimposed on DC voltage to the charging member (AC/DC charging system).

An image forming apparatus equipped with a charging device that has a contact system and a DC charging system has a tendency to generate fogging when images are continuously formed. Generation of fogging that would occur during continuous image formation is inhibited by using the electrophotographic photoreceptor of this exemplary embodiment with an image forming apparatus equipped with a charging device that has a contact system and a DC charging system.

The image forming apparatus of the exemplary embodiment is applied to a known image forming apparatus, examples of which include an apparatus equipped with a fixing device that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning device that cleans the surface of the electrophotographic photoreceptor after the toner image transfer and before charging; and an apparatus equipped with an electrophotographic photoreceptor-heating member that increases the temperature of the electrophotographic photoreceptor to decrease the relative temperature.

In the intermediate transfer type apparatus, the transfer device includes, for example, an intermediate transfer body having a surface onto which a toner image is to be transferred, a first transfer device that conducts first transfer of the toner image on the surface of the electrophotographic photoreceptor onto the surface of the intermediate transfer body, and a second transfer device that conducts second transfer of the toner image on the surface of the intermediate transfer body onto a surface of a recording medium.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus. A process cartridge equipped with the photoreceptor of the present exemplary embodiment may be used as this process cartridge. The process cartridge may include, in addition to the electrophotographic photoreceptor, at least one selected from the group consisting of a charging device, an electrostatic latent image forming device, a developing device, and a transfer device.

Although some examples of the image forming apparatus of the present exemplary embodiment are described below, these examples are not limiting. Only relevant parts illustrated in the drawings are described, and descriptions of other parts are omitted.

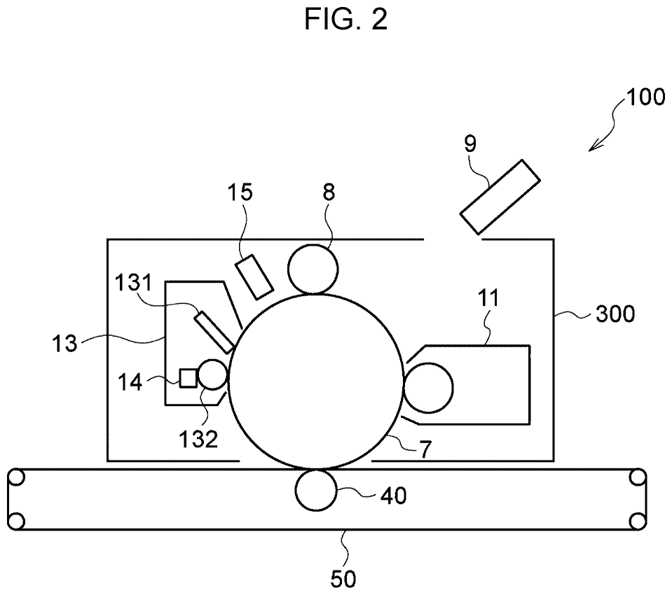

FIG. 2 is a schematic cross-sectional view of one example of an image forming apparatus according to one exemplary embodiment.

As illustrated in FIG. 2, an image forming apparatus 100 of this exemplary embodiment includes a process cartridge 300 equipped with an electrophotographic photoreceptor 7, an exposing device 9 (one example of the electrostatic latent image forming device), a transfer device 40 (first transfer device), and an intermediate transfer body 50. In this image forming apparatus 100, the exposing device 9 is positioned so that light can be applied to the electrophotographic photoreceptor 7 from the opening of the process cartridge 300, the transfer device 40 is positioned to oppose the electrophotographic photoreceptor 7 with the intermediate transfer body 50 therebetween, and the intermediate transfer body 50 has a portion in contact with the electrophotographic photoreceptor 7. Although not illustrated in the drawings, a second transfer device that transfers the toner image on the intermediate transfer body 50 onto a recording medium (for example, a paper sheet) is also provided. The intermediate transfer body 50, the transfer device 40 (first transfer device), and the second transfer device (not illustrated) correspond to examples of the transfer device.

The process cartridge 300 illustrated in FIG. 2 integrates and supports the electrophotographic photoreceptor 7, a charging device 8 (one example of the charging device), a developing device 11 (one example of the developing device), and a cleaning device 13 (one example of the cleaning device) in the housing. The cleaning device 13 has a cleaning blade (one example of the cleaning member) 131, and the cleaning blade 131 is in contact with the surface of the electrophotographic photoreceptor 7. The cleaning member may take a form other than the cleaning blade 131, and may be a conductive or insulating fibrous member that can be used alone or in combination with the cleaning blade 131.

Although an example of the image forming apparatus equipped with a fibrous member 132 (roll) that supplies a lubricant 14 to the surface of the electrophotographic photoreceptor 7 is illustrated in FIG. 2, the fibrous member 132 is provided as necessary.

The features of the image forming apparatus of this exemplary embodiment will now be described.

### Charging Device

Examples of the charging device 8 include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also used.

The charging device 8 may be a contact-type charging device or a non-contact type charging device. The charging device 8 may be a DC charging system charging device, an AC charging system charging device, or an AC/DC charging system charging device. Exemplary embodiments of the charging device 8 include a charging device that has a contact system and a DC charging system.

### Exposing Device

Examples of the exposing device 9 include optical devices that can apply light, such as semiconductor laser light, LED light, or liquid crystal shutter light, into a particular image shape onto the surface of the electrophotographic photoreceptor 7. The wavelength of the light source is to be within the spectral sensitivity range of the electrophotographic photoreceptor. The mainstream wavelength of the semiconductor lasers is near infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may also be used. In order to form a color image, a surface-emitting laser light source that can output multi beams is also effective.

### Developing Device

Examples of the developing device 11 include common developing devices that perform development by using a developer in contact or non-contact manner. The developing device 11 is not particularly limited as long as the aforementioned functions are exhibited, and is selected according to the purpose. An example thereof is a known developer that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Known developers are used as these developer.

### Cleaning Device

A cleaning blade type device equipped with a cleaning blade 131 is used as the cleaning device 13. A fur brush cleaning method or a simultaneous development/cleaning method may be employed instead of the cleaning blade method.

### Charge Erasing Device

The charge erasing device 15 irradiates the surface of the electrophotographic photoreceptor 7 with charge erasing device to remove the remaining potentials on the electrophotographic photoreceptor 7. The charge erasing device 15 is a light emitting device that irradiates all areas of the electrophotographic photoreceptor 7 in the rotation axis direction with light, and examples thereof include a halogen lamp, a tungsten lamp, and an LED lamp. The wavelength of the charge erasing light is, for example, 600 nm or more and 700 nm or less, and the intensity of the charge erasing light is, for example, 5 mJ/m² or more and 100 mJ/m² or less.

The electrophotographic photoreceptor 7 that has transferred the toner image to the intermediate transfer body 50 has adhering matters, such as residual toner, adhering to the surface removed by the cleaning device 13, and charges remaining on the surface is removed by irradiation with charge erasing light from the charge erasing device 15.

FIG. 2 illustrates the case in which the charge erasing device 15 is disposed downstream of the cleaning device 13; alternatively, the charge erasing device 15 may be disposed upstream of the cleaning device 13.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber, or the like is used as the intermediate transfer body 50. The form of the intermediate transfer body other than the belt may be a drum.

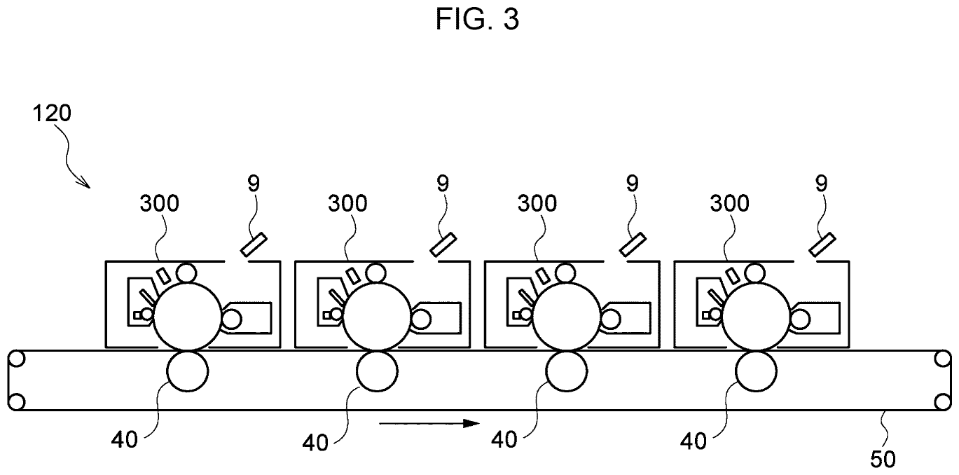

FIG. 3 is a schematic cross-sectional view of one example of an image forming apparatus according to one exemplary embodiment.

An image forming apparatus 120 illustrated in FIG. 3 is a tandem-system multicolor image forming apparatus equipped with four process cartridges 300. In the image forming apparatus 120, four process cartridges 300 are arranged side-by-side on the intermediate transfer body 50, and one electrophotographic photoreceptor is used for one color. The image forming apparatus 120 is identical to the image forming apparatus 100 except for the tandem system.

### EXAMPLES

In the description below, the exemplary embodiments of the present disclosure are described in further detail through examples, and these examples in no way limit the exemplary embodiments of the present disclosure in any way.

In the description below, “parts” and “%” are on a mass basis unless otherwise noted.

In the description below, syntheses, production, processes, measurement, etc., are carried out at room temperature (25° C.±3° C.) unless otherwise noted.

### Production of Photoreceptor

### Example 1

### Formation of Undercoat Layer

An aluminum tube having an outer diameter of 30 mm, a length of 365 mm, and a thickness of 1 mm is prepared as a conductive substrate.

One hundred parts of zinc oxide (average particle size: 70 nm, specific surface area: 15 m²/g, produced by TAYCA CORPORATION) is mixed and stirred with 500 parts of toluene, 1.3 parts of a silane coupling agent (N-2-(aminoethyl)-3-aminopropyltrimethoxysilane, product name: KBM603, produced by Shin-Etsu Chemical Co., Ltd.) is added thereto, and the resulting mixture is stirred for 2 hours. Next, toluene is distilled away under a reduced pressure, baking is performed at 120° C. for 3 hours, as a result of which zinc oxide surface-treated with a silane coupling agent is obtained.

With 500 parts of tetrahydrofuran, 110 parts of the surface-treated zinc oxide is mixed and stirred, a solution prepared by dissolving 0.6 parts of alizarin in 50 parts of tetrahydrofuran is added thereto, and the resulting mixture is stirred at 50° C. for 5 hours. The resulting mixture is filtered at a reduced pressure to filter out the solid component, and the solid component is dried at 60° C. at a reduced pressure to obtain alizarin-attached zinc oxide.

One hundred parts of a solution prepared by dissolving 60 parts of the alizarin-attached zinc oxide, 13.5 parts of a curing agent (blocked isocyanate, product name: Sumidur 3175 produced by Sumitomo Bayer Urethane Co., Ltd.), and 15 parts of a butyral resin (product name: S-LEC BM-1 produced by SEKISUI CHEMICAL CO., LTD.) in 68 parts of methyl ethyl ketone is mixed with 5 parts of methyl ethyl ketone, and the resulting mixture is dispersed in a sand mill with glass beads having a diameter of 1 mm for 2 hours to obtain a dispersion. To the dispersion, 0.005 parts of dioctyl tin dilaurate serving as a catalyst and 4 parts of silicone resin particles (product name: Tospearl 145 produced by Momentive Performance Materials Japan LLC) are added to prepare an undercoat layer-forming solution. The undercoat layer-forming solution is applied to an outer circumferential surface of the conductive substrate and dried and cured at 170° C. for 40 minutes to form an undercoat layer having an average thickness of 25 μm.

### Formation of Charge Generation Layer

A mixture containing 15 parts of hydroxygallium phthalocyanine (having diffraction peaks at least at Bragg's angles (20+) 0.2° of 7.5°, 9.9°, 12.5°, 16.3°, 18.6°, 25.1°, and 28.3° in an X-ray diffraction spectrum taken with CuK α specific X-ray) serving as a charge generation material, 10 parts of a vinyl chloride-vinyl acetate copolymer resin (product name: VMCH produced by Nippon Unicar Company Limited) serving as a binder resin, and 200 parts of n-butyl acetate is dispersed in a sand mill with glass beads having a diameter of 1 mm for 4 hours. To the dispersion, 175 parts of n-butyl acetate and 180 parts of methyl ethyl ketone are added and the resulting mixture is stirred to prepare a charge generation layer-forming solution. The charge generation layer-forming solution is applied to the undercoat layer by dip coating and dried at room temperature (25° C.±3° C.) to form a charge generation layer having an average thickness of 0.18 μm.

### Formation of Charge Transport Layer

Binder resin: polycarbonate resin (PC1) (viscosity-average molecular weight: 50,000), 50 parts
Charge transport material: CTM (1), 50 parts
Solvent: tetrahydrofuran, 200 parts
Solvent: toluene, 50 parts

The aforementioned materials are mixed to obtain a charge transport layer-forming solution. The charge transport layer-forming solution is applied to the charge generation layer by dip coating and dried at 145° C. for 30 minutes to form a charge transport layer having a thickness of 11.0 μm.

The chemical structures of the polycarbonate resin (PC1) and CTM(1) are as follows. In the structural formula of the polycarbonate resin (PC1), figures represent molar ratios.

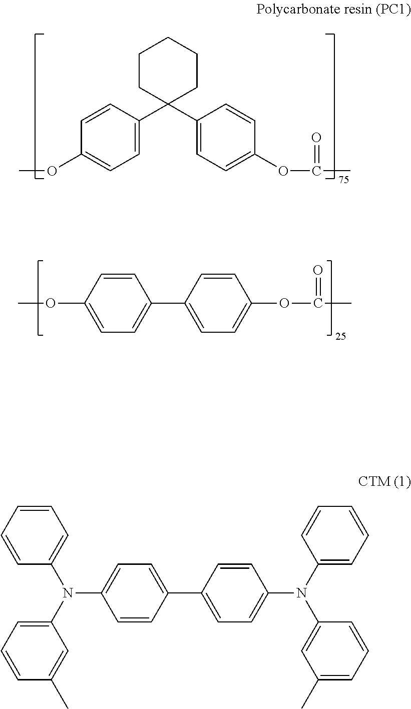

### Formation of Protection Layer

Reactive charge transport material: CTM(R1), 70 parts
Reactive charge transport material: CTM(R2), 15 parts
Reactive non-charge transport material (thermosetting resin): benzoguanamine resin (product name: NIKALAC BL-60 produced by Sanwa Chemical Co., Ltd.), 4.4 parts
Curing catalyst: NACURE 5225 (King Industries, Inc.), 0.1 parts
Solvent: 2-propanol, 220 parts

The aforementioned materials are mixed to obtain a protection layer-forming solution. The protection layer-forming solution is applied to the charge transport layer by dip coating and left to stand at room temperature (25° C.±3° C.) for 30 minutes to dry. Next, the resulting product is placed in a heating furnace and heat-treated in a nitrogen stream at an oxygen concentration of 110 ppm at a temperature of 155° C. for 20 minutes to cure the protection layer and thereby form a protection layer having a thickness of 7.0 μm.

The chemical structures of CTM(R1) and CTM(R2) are as follows.

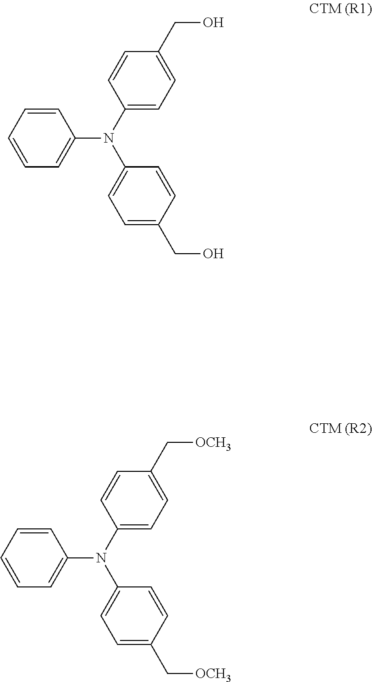 [SMILES: OCc1ccc(N(c2ccccc2)c2ccc(CO)cc2)cc1 ; COCc1ccc(N(c2ccccc2)c2ccc(COC)cc2)cc1]

### Examples 2 to 7 and Comparative Examples 1 and 2

Photoreceptors are produced as in Example 1 except that the thickness of the charge transport layer and the thickness of the protection layer are changed as indicated in Table.

### Example 11

A photoreceptor is produced as in Example 1 except for the following changes in forming the charge transport layer and the protection layer.

### Formation of Charge Transport Layer

Binder resin: polyarylate resin (PA1) (weight-average average molecular weight: 80,000), 50 parts
Charge transport material: CTM (2), 50 parts
Solvent: tetrahydrofuran, 200 parts
Solvent: toluene, 50 parts

The aforementioned materials are mixed to obtain a charge transport layer-forming solution. The charge transport layer-forming solution is applied to the charge generation layer by dip coating and dried at 145° C. for 30 minutes to form a charge transport layer having a thickness of 11.0 μm.

The chemical structures of the polyarylate resin (PA1) and CTM(2) are as follows. In the structural formula of the polyarylate resin (PA1), numerical figures represent molar ratios.

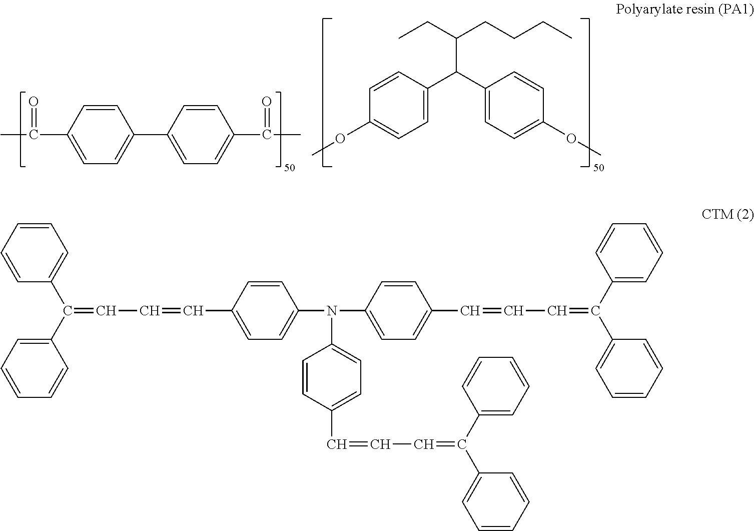

### Formation of Protection Layer

Reactive charge transport material: CTM(R1), 70 parts
Reactive charge transport material: CTM(R2), 15 parts
Reactive non-charge transport material (thermosetting resin): benzoguanamine resin (product name: NIKALAC BL-60 produced by Sanwa Chemical Co., Ltd.), 4.4 parts
Curing catalyst: NACURE 5225 (King Industries, Inc.), 0.1 parts
Solvent: 2-propanol, 220 parts

The aforementioned materials are mixed to obtain a protection layer-forming solution. The protection layer-forming solution is applied to the charge transport layer by dip coating and left to stand at room temperature (25° C.±3° C.) for 30 minutes to dry. Next, the resulting product is placed in a heating furnace and heat-treated in a nitrogen stream at an oxygen concentration of 110 ppm at a temperature of 155° C. for 20 minutes to cure the protection layer and thereby form a protection layer having a thickness of 7.0 μm.

### Examples 12 to 17 and Comparative Examples 11 and 12

Photoreceptors are produced as in Example 11 except that the thickness of the charge transport layer and the thickness of the protection layer are changed as indicated in Table.

### Performance Evaluation

DocuCentre-V C2263 (FUJIFILM Business Innovation Corp.) is prepared as an image forming apparatus equipped with a contact system, DC charging system charging device that has a charging roller as a charging member, and a charge erasing device that erases charge by light irradiation. The charge erasing device includes an LED lamp as the charge erasing light source, the wavelength of the charge erasing light is 600 nm or more and 700 nm or less, and the charge erasing light intensity is 50 mJ/m². The photoreceptor of Example or Comparative Example is installed in the image forming apparatus.

### Decrease in Surface Potential

The following operation is continuously performed in an environment having a temperature of 28° C. and a relative humidity of 85%.

A potential probe of a surface electrometer (Model 347 produced by Trek Japan) is installed at a position of a developing unit of the image forming apparatus described above. Five sheets of regular A4 paper are fed, and the initial surface potential (V) is measured. The potential probe is removed, and 1000 sheets of regular A4 paper are fed. The potential probe is again installed at the position of the developing unit, 5 sheets of regular A4 paper are fed, and the surface potential (V) after continuous paper feed is measured. The surface potential (V) after continuous paper feed is subtracted from the initial surface potential (V) to calculate the decrease in surface potential (V). The results are indicated in Table. A decrease in surface potential of less than 25 V is an acceptable range.

### Fogging

The same image forming apparatus is used to output a solid black image on 1000 sheets of regular A4 paper in an environment having a temperature of 22° C. and a relative humidity of 55%. Subsequently, 5 sheets of regular A4 paper are fed, and these 5 sheets are visually examined and graded as follows.
A: No fogging is found.
B: Fogging is found but the extent thereof is in the acceptable range.
C: Extensive fogging is found and the extent thereof is beyond the acceptable range.

### Charging Leakage

The following operation is continuously performed in an environment having a temperature of 22° C. and a relative humidity of 55%.

Voltage of 2 kV is applied to the charging roller of the aforementioned image forming apparatus, and, after 30 minutes, electricity is discharged onto one point on the surface of the photoreceptor, and whether or not a black spot occurs due to the pinhole is confirmed.
A: No black spot (leakage) is found.
B: Very small black spot (leakage) is found but the extent thereof is in the acceptable range.
C: Extensive black spot (leakage) is found and the extent thereof is beyond the acceptable range.

TABLE

| | | | | | | | Charge transport layer and | | | | | |
|---|---|---|---|---|---|---|---|---|---|---|---|---|
| | | | | | | | protection layer as a whole | | | | | |
| | Charge transport layer | | | Protection layer | | Thick- | Total | | | Photoreceptor | | |
| | | Thick- | | Thick- | | ness | thick- | | | Decrease | | |
| | | ness | Dielectric | ness | Dielectric | ratio | ness | Dielectric | | in surface | | Charging |
| | Binder resin | L1 | constant ε | L2 | constant ε | L2/L1 | L(L1 + L2) | constant ε | L/ε | potential | Fogging | leakage |
| | Type | μm | F/m | μm | F/m | — | μm | F/m | — | V | — | — |
| Comparative | Polycarbonate | 14.0 | 3.20 | 7.0 | 3.80 | 0.50 | 21.0 | 3.40 | 6.2 | 25 | C | A |
| Example 1 | | | | | | | | | | | | |
| Example 6 | Polycarbonate | 8.0 | 3.20 | 9.0 | 3.80 | 1.13 | 17.0 | 3.40 | 5.0 | 21 | B | A |
| Example 4 | Polycarbonate | 13.0 | 3.20 | 7.5 | 3.80 | 0.58 | 20.5 | 3.40 | 6.0 | 21 | B | A |
| Example 2 | Polycarbonate | 13.0 | 3.20 | 7.0 | 3.80 | 0.54 | 20.0 | 3.40 | 5.9 | 18 | A | A |
| Example 1 | Polycarbonate | 11.0 | 3.20 | 7.0 | 3.80 | 0.64 | 18.0 | 3.40 | 5.3 | 16 | A | A |
| Example 3 | Polycarbonate | 11.0 | 3.20 | 4.0 | 3.80 | 0.36 | 15.0 | 3.30 | 4.5 | 13 | A | A |
| Example 5 | Polycarbonate | 11.0 | 3.20 | 2.0 | 3.80 | 0.18 | 13.0 | 3.30 | 3.9 | 12 | A | B |
| Example 7 | Polycarbonate | 11.0 | 3.20 | 1.0 | 3.80 | 0.09 | 12.0 | 3.30 | 3.6 | 11 | A | B |
| Comparative | Polycarbonate | 8.5 | 3.20 | 1.0 | 3.80 | 0.12 | 9.5 | 3.30 | 2.9 | 9 | A | C |
| Example 2 | | | | | | | | | | | | |
| Comparative | Polyarylate | 14.0 | 3.30 | 7.0 | 3.80 | 0.50 | 21.0 | 3.45 | 6.1 | 23 | C | A |
| Example 11 | | | | | | | | | | | | |
| Example 16 | Polyarylate | 8.0 | 3.30 | 9.0 | 3.80 | 1.13 | 17.0 | 3.50 | 4.9 | 21 | B | A |
| Example 14 | Polyarylate | 13.0 | 3.30 | 7.5 | 3.80 | 0.58 | 20.5 | 3.50 | 5.9 | 20 | B | A |
| Example 12 | Polyarylate | 13.0 | 3.30 | 7.0 | 3.80 | 0.54 | 20.0 | 3.44 | 5.8 | 17 | A | A |
| Example 11 | Polyarylate | 11.0 | 3.30 | 7.0 | 3.80 | 0.64 | 18.0 | 3.42 | 5.3 | 16 | A | A |
| Example 13 | Polyarylate | 11.0 | 3.30 | 4.0 | 3.80 | 0.36 | 15.0 | 3.35 | 4.5 | 13 | A | A |
| Example 15 | Polyarylate | 11.0 | 3.30 | 2.0 | 3.80 | 0.18 | 13.0 | 3.40 | 3.8 | 12 | A | B |
| Example 17 | Polyarylate | 11.0 | 3.30 | 1.0 | 3.80 | 0.09 | 12.0 | 3.40 | 3.5 | 11 | A | B |
| Comparative | Polyarylate | 8.0 | 3.30 | 1.0 | 3.80 | 0.13 | 9.0 | 3.32 | 2.7 | 8 | A | C |
| Example 12 | | | | | | | | | | | | |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An electrophotographic photoreceptor comprising:
a conductive substrate;
a charge generation layer on the conductive substrate;
a charge transport layer on the charge generation layer; and
a protection layer on the charge transport layer,
wherein a ratio L/ε of a total thickness L (μm) of the charge transport layer and the protection layer to a dielectric constant ε (F/m) of the charge transport layer and the protection layer as a whole in a thickness direction is 3 or more and 6 or less.
   (((2)))

The electrophotographic photoreceptor described in (((1))), wherein the ratio L/ε is 4.5 or more and 5.5 or less.

(((3)))

The electrophotographic photoreceptor described in (((1))) or (((2))), wherein the protection layer is a cured film or crosslinked film of a composition containing a reactive charge transport material.

(((4)))

The electrophotographic photoreceptor described in any one of (((1))) to (((3))), wherein the total thickness L is 10 μm or more and 20 μm or less.

(((5))

The electrophotographic photoreceptor described in any one of (((1))) to (((4))), wherein a ratio L2/L1 of a thickness L2 of the protection layer to a thickness L1 of the charge transport layer is 0.1 or more and 1 or less.

(((6)))

The electrophotographic photoreceptor described in any one of (((1))) to (((5))), wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.
   (((7)))

A process cartridge detachably attachable to an image forming apparatus, the process cartridge comprising the electrophotographic photoreceptor described in any one of (((1))) to (((5))).

(((8)))

The process cartridge described in (((7))), further comprising a charge erasing device that removes charges by irradiating the surface of the electrophotographic photoreceptor with charge erasing light after transfer of a toner image onto a surface of a recording medium.

(((9)))

The process cartridge described in (((7))) or (((8))), further comprising a charging device that charges the surface of the electrophotographic photoreceptor, has a charging member that contacts the electrophotographic photoreceptor, and applies only DC voltage to the charging member.

(((10)))

An image forming apparatus comprising:
the electrophotographic photoreceptor described in any one of (((1))) to (((5)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image on the surface of the electrophotographic photoreceptor by using a developer containing a toner so as to form a toner image;
a transfer device that transfers the toner image onto a surface of a recording medium; and
a charge erasing device that removes charges by irradiating the surface of the electrophotographic photoreceptor with charge erasing light after transfer of the toner image onto the surface of the recording medium.
   (((11)))

The image forming apparatus described in (((10))), wherein the charging device is a charging device that has a charging member that contacts the electrophotographic photoreceptor, and applies only DC voltage to the charging member.

What is claimed is:

1. An electrophotographic photoreceptor comprising:
a conductive substrate;
a charge generation layer on the conductive substrate;
a charge transport layer on the charge generation layer; and
a protection layer on the charge transport layer,
wherein a ratio L/ε f a total thickness L (μm) of the charge transport layer and the protection layer to a dielectric constant ε (F/m) of the charge transport layer and the protection layer as a whole in a thickness direction is 3 or more and 6 or less.

2. The electrophotographic photoreceptor according to claim 1, wherein the ratio L/ε is 4.5 or more and 5.5 or less.

3. The electrophotographic photoreceptor according to claim 1, wherein the protection layer is a cured film or crosslinked film of a composition containing a reactive charge transport material.

4. The electrophotographic photoreceptor according to claim 1, wherein the total thickness L is 10 μm or more and 20 μm or less.

5. The electrophotographic photoreceptor according to claim 1, wherein a ratio L2/L1 of a thickness L2 of the protection layer to a thickness L1 of the charge transport layer is 0.1 or more and 1 or less.

6. The electrophotographic photoreceptor according to claim 1, wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.

7. The electrophotographic photoreceptor according to claim 2, wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.

8. The electrophotographic photoreceptor according to claim 3, wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.

9. The electrophotographic photoreceptor according to claim 4, wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.

10. The electrophotographic photoreceptor according to claim 5, wherein the electrophotographic photoreceptor is for use in an image forming apparatus that includes:
a charging device that charges a surface of the electrophotographic photoreceptor, has a charging member that contacts the electrophotographic photoreceptor, and applies only DC voltage to the charging member; and
a charge erasing device that removes charges by irradiating the surface of the electrophotographic photoreceptor with charge erasing light after transfer of a toner image onto a surface of the recording medium.

11. A process cartridge detachably attachable to an image forming apparatus, the process cartridge comprising the electrophotographic photoreceptor according to claim 1.

12. A process cartridge detachably attachable to an image forming apparatus, the process cartridge comprising the electrophotographic photoreceptor according to claim 2.

13. A process cartridge detachably attachable to an image forming apparatus, the process cartridge comprising the electrophotographic photoreceptor according to claim 3.

14. A process cartridge detachably attachable to an image forming apparatus, the process cartridge comprising the electrophotographic photoreceptor according to claim 4.

15. A process cartridge detachably attachable to an image forming apparatus, the process cartridge comprising the electrophotographic photoreceptor according to claim 5.

16. The process cartridge according to claim 11, further comprising a charge erasing device that removes charges by irradiating the surface of the electrophotographic photoreceptor with charge erasing light after transfer of a toner image onto a surface of a recording medium.

17. The process cartridge according to claim 12, further comprising a charge erasing device that removes charges by irradiating the surface of the electrophotographic photoreceptor with charge erasing light after transfer of a toner image onto a surface of a recording medium.

18. The process cartridge according to claim 16, further comprising a charging device that charges the surface of the electrophotographic photoreceptor, has a charging member that contacts the electrophotographic photoreceptor, and applies only DC voltage to the charging member.

19. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image on the surface of the electrophotographic photoreceptor by using a developer containing a toner so as to form a toner image;
a transfer device that transfers the toner image onto a surface of a recording medium; and
a charge erasing device that removes charges by irradiating the surface of the electrophotographic photoreceptor with charge erasing light after transfer of the toner image onto the surface of the recording medium.

20. The image forming apparatus according to claim 19, wherein the charging device is a charging device that has a charging member that contacts the electrophotographic photoreceptor, and applies only DC voltage to the charging member.
